(19) United States
(12) Patent Application Publication
(10) Pub. No.: US 2025/0244777 A1
(43) Pub. Date: Jul. 31, 2025

(54) CONTROL DEVICE

(71) Applicant: TOYOTA JIDOSHA KABUSHIKI KAISHA, Toyota-shi (JP)

(72) Inventors: Kento IWAHORI, Nagoya-shi (JP); Shogo YASUYAMA, Okazaki-shi (JP)

(73) Assignee: TOYOTA JIDOSHA KABUSHIKI KAISHA, Toyota-shi (JP)

(21) Appl. No.: 18/975,330

(22) Filed: Dec. 10, 2024

(30) Foreign Application Priority Data
Jan. 30, 2024 (JP) 2024-011863

(51) Int. Cl. G05D 1/86; G05D 1/226; G05D 1/249; G05D 107/70; G05D 109/10; G05D 111/30; G06T 7/70

(52) U.S. Cl. CPC G05D 1/86; G05D 1/226; G05D 1/249; G06T 7/70; G05D 2107/70; G05D 2109/10; G05D 2111/30; G06T 2207/30252

(57) ABSTRACT

A control device that controls a mobile body that travels through unattended driving and the mobile body performs communication for controlling travel of the mobile body through the unattended driving and communication for inspecting the mobile body via an identical line. The control device includes a position acquisition unit that acquires position information indicating a current position of the mobile body, a storage unit storing first information indicating one or more inspections performed on the mobile body on a scheduled travel route of the mobile body and a point associated with each of the inspections where the inspection is performed on the travel route, and second information indicating a communication load in communication for the inspection and associated with the inspection, and a determination unit determining whether to cause the mobile body to travel through the unattended driving based on the position information, the first information, and the second information.

### CROSS-REFERENCE TO RELATED APPLICATION

This application claims priority to Japanese Patent Application No. 2024-011863 filed on Jan. 30, 2024, incorporated herein by reference in its entirety.

### BACKGROUND

### 1. Technical Field

The present disclosure relates to a control device.

### 2. Description of Related Art

Japanese Unexamined Patent Application Publication (Translation of PCT Application) No. 2017-538619 (JP 2017-538619 A) describes a vehicle that is an object to be manufactured and that travels through remote control, in a manufacturing process for manufacturing vehicles.

### SUMMARY

In a manufacturing process, a vehicle in an incomplete state may be driven through remote control between a plurality of processes, or a traveling vehicle may be inspected from a remote location. In such cases, the vehicle and a control device located at a remote location may communicate via diagnostic link connectors (DLCs). In such an aspect, it is assumed that the communication band is squeezed by both communication for travel control and communication for inspection, causing a communication failure. For this reason, there has been a demand for a technique capable of avoiding a squeeze on the communication band due to remote control for travel of vehicles and inspection.

The present disclosure can be implemented in the following aspects.

(1) A first aspect of the present disclosure provides a control device that controls a mobile body that travels through unattended driving. The control device and the mobile body perform communication for controlling travel of the mobile body through the unattended driving and communication for inspecting the mobile body via an identical line. The control device includes:
a position acquisition unit that acquires position information that indicates a current position of the mobile body;
a storage unit that stores
first information that indicates one or more inspections performed on the mobile body on a scheduled travel route of the mobile body and a point associated with each of the inspections where the inspection is performed on the travel route, and
second information that indicates the inspection and a communication load in communication for the inspection and associated with the inspection; and
a determination unit that determines whether to cause the mobile body to travel through the unattended driving based on the position information, the first information, and the second information.

According to the above aspect, it is possible to easily determine whether to continue travel of the mobile body by using the position information indicating the current position of the mobile body, the first information indicating one or more inspections performed on the mobile body on the scheduled travel route and the point where the inspection is performed, and the second information indicating the communication load in the inspection performed on the mobile body.

(2) In the control device according to the above aspect,
the determination unit may be configured to:
specify the inspection to be performed next based on the position information and the first information; and
determine not to cause the mobile body to travel through the unattended driving when the communication load in execution of the specified inspection meets a condition determined in advance based on the specified inspection and the second information.

According to the above aspect, when the communication load at the time of performing the inspection meets a condition determined in advance, the mobile body is not caused to travel through the unattended driving. Therefore, communication for controlling travel of the mobile body is restricted, and thus it is possible to avoid a squeeze on the communication band.

(3) In the control device according to the above aspect, the second information may further include information that indicates whether travel of the mobile body is required for the inspection. The determination unit may be configured to specify the inspection to be performed next based on the position information and the first information,
determine based on the second information whether travel of the mobile body is enabled for the specified inspection, and
when the specified inspection requires travel of the mobile body,
cause the mobile body to travel through the unattended driving, and
determine to perform only an inspection item that requires travel based on the second information, among a plurality of inspection items included in the specified inspection.

(4) In the control device according to the above aspect, the second information may further include information that indicates a process to be preferentially performed, among execution of the inspection and movement of the mobile body. The determination unit may be configured to
specify the inspection to be performed next based on the position information and the first information,
when it is determined to perform the execution of the specified inspection in preference to the movement of the mobile body, perform the specified inspection without causing the mobile body to travel, and
when it is determined to perform the movement of the mobile body in preference to the execution of the specified inspection, cause the mobile body to travel, stop communication for controlling travel of the mobile body when the mobile body arrives at a destination, and thereafter perform the inspection.

According to the above aspect, it is possible to easily determine which of the movement of the mobile body and the execution of the inspection should be prioritized.

(5) The control device according to the above aspect may further include at least one of:
a notification unit that notifies a user that the mobile body is caused to travel through the unattended driving when the determination unit determines to cause the mobile body to travel through the unattended driving; or
an output unit that outputs a log that indicates that the determination unit has determined to cause the mobile body to travel through the unattended driving when the determination unit makes such a decision.

The present disclosure can be implemented in various forms, and can be implemented in the form of a remote control system, a vehicle control device, a remote autonomous driving method, a vehicle manufacturing method, and the like, for example.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating a configuration of a system according to a first embodiment;

FIG. 2 is a block diagram illustrating a schematic configuration of the system according to the first embodiment;

FIG. 3 is an explanatory diagram illustrating an example of an inspection item;

FIG. 4 is an explanatory diagram illustrating an example of an execution point;

FIG. 5 is an explanatory diagram illustrating an example of an inspection load;

FIG. 6 is a flowchart illustrating a processing procedure of travel control of the vehicle according to the first embodiment;

FIG. 7 is a flowchart illustrating a processing procedure related to an inspection in the first embodiment;

FIG. 8 is an explanatory diagram illustrating an example of an inspection load according to the third embodiment;

FIG. 9 is a flowchart illustrating a first half of a processing procedure related to inspection in the third embodiment;

FIG. 10 is a flowchart illustrating a second half of a processing procedure related to an inspection according to the third embodiment;

FIG. 11 is an explanatory diagram illustrating an example of an inspection load according to the fourth embodiment;

FIG. 12 is a flow chart showing a process sequence related to an examination in the fourth embodiment; and

FIG. 13 is an explanatory diagram of a case where the vehicle is evacuated to the evacuation area.

### DETAILED DESCRIPTION OF EMBODIMENTS

### A. First Embodiment

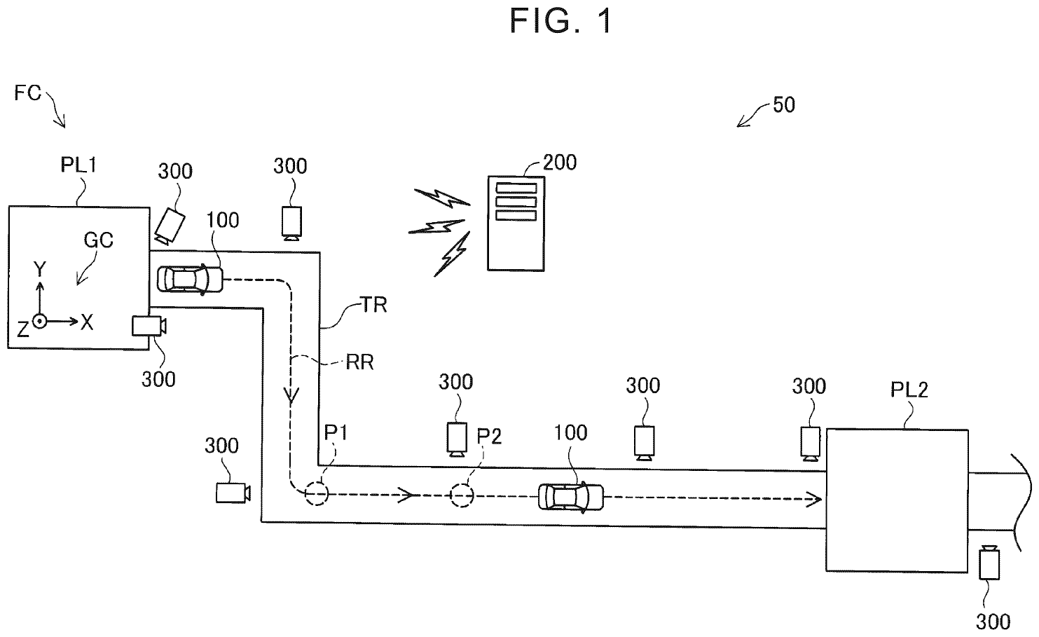

FIG. 1 is a conceptual diagram illustrating a configuration of a system 50 according to a first embodiment. In a factory FC for manufacturing a moving object, the system 50 is used to move the vehicle 100, which is a moving object, by unmanned driving. The system 50 includes one or more vehicles 100, a server 200, and a plurality of external sensors 300. Vehicles 100 are BEV (Battery Electric Vehicle).

The vehicle 100 is configured to be able to travel by unmanned driving. The term “unmanned driving” means driving that does not depend on the traveling operation of the passenger. The traveling operation means an operation related to at least one of “running”, “turning”, and “stopping” of the vehicle 100. Unmanned driving is realized by automatic remote control using a device located outside the vehicle 100. A passenger who does not perform the traveling operation may be on the vehicle 100 traveling by the unmanned driving. The passenger who does not perform the traveling operation includes, for example, a person who is simply seated on the seat of the vehicle 100 and a person who performs a work different from the traveling operation such as an assembling operation, an inspection operation, and an operation of switches while riding on the vehicle 100. Driving by the traveling operation of the occupant is sometimes referred to as “manned driving”.

Herein, “remote control” includes “full remote control” in which all of the operations of the vehicle 100 are completely determined from the outside of the vehicle 100, and “partial remote control” in which a part of the operations of the vehicle 100 is determined from the outside of the vehicle 100.

The reference coordinate system of the factory FC is a global coordinate system GC, and any position in the factory FC can be represented by the coordinates of X, Y, Z in the global coordinate system GC. The factory FC includes a first location PL1 and a second location PL2. The first location PL1 and the second location PL2 are connected by a road TR on which the vehicles 100 can travel. In the factory FC, a plurality of external sensors 300 are installed along the road TR. The positions of the external sensors 300 in the factory FC are adjusted in advance. The vehicles 100 travel through the road TR from the first location PL1 to the second location PL2 by unmanned driving.

The vehicle 100 is manufactured through a plurality of processes. The first location PL1 is a location where an operation of assembling the vehicles 100 is performed. For example, in the first location PL1, an assembling operation of a component is performed by an assembling robotic device (not shown). In the first location PL1, the vehicle 100 on which the component is assembled is in the form of a finished vehicle. The vehicles 100 move from the first location PL1 to the second location PL2 by unmanned driving.

In the second location PL2, the vehicles 100 that are in the condition of the finished vehicle prior to shipping are inspected. The vehicle 100 that has been inspected is moved to a completed vehicle yard (not shown) through the road TR by unmanned driving.

In the present embodiment, one or more inspections are performed on the vehicle 100 while the vehicle 100 assembled in the first location PL1 moves from the first location PL1 to the second location PL2.

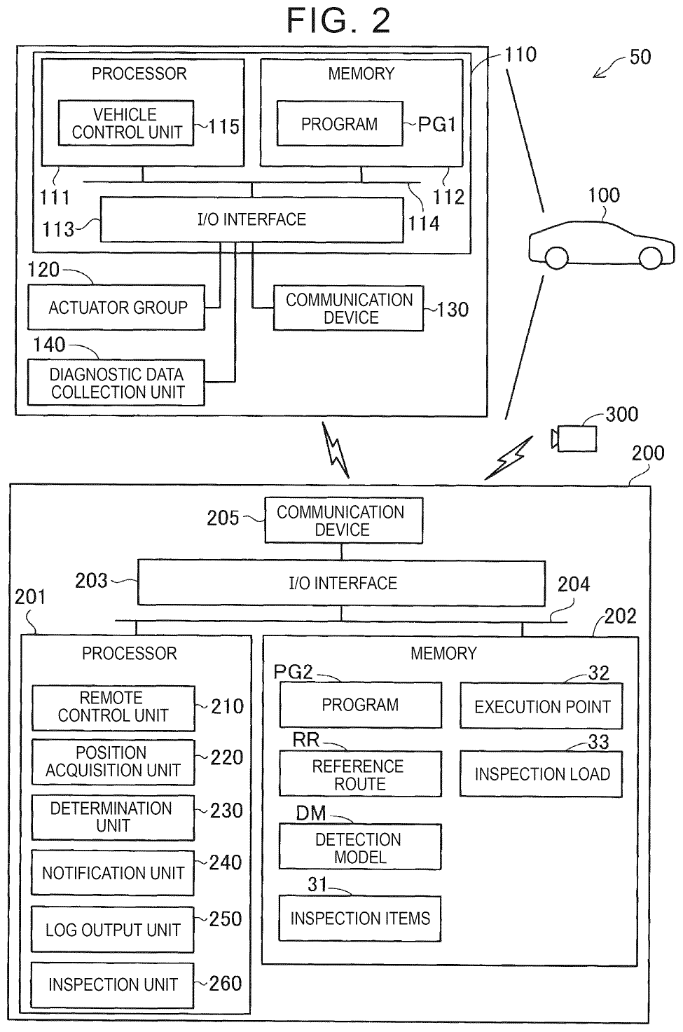

FIG. 2 is a block diagram illustrating a schematic configuration of the system 50. The vehicle 100 includes a vehicle control device 110 for controlling each unit of the vehicle 100, an actuator group 120, a communication device 130, and a diagnostic data collection unit 140. The actuator group 120 includes one or more actuators driven under the control of each vehicle control device 110. The communication device 130 communicates with an external device such as the server 200 by wireless communication.

The vehicle control device 110 includes an ECU (Electronic Control Unit) including a processor 111, a memory 112, an input/output interface 113, and an internal bus 114. The processor 111, the memory 112, and the input/output interface 113 are bidirectionally communicably connected via an internal bus 114. An actuator group 120 and a communication device 130 are connected to the input/output interface 113. The processor 111 executes the program PG1 stored in the memory 112 to realize various functions including functions as the vehicle control unit 115.

The actuator group 120 includes an actuator of a driving device for accelerating the vehicle 100, an actuator of a steering device for changing a traveling direction of the vehicle 100, an actuator of a braking device for decelerating the vehicle 100, and the like.

The communication device 130 is, for example, a radio communication device connected to a DLC (Data Link Connector) provided in the vehicle 100. The vehicle 100 and the server 200 communicate with each other through a dialog communication. Diagnostic communication is communication used for fault diagnosis. For example, a diagnostic tool connected to a DLC provided in the vehicle 100 can acquire data from various ECU provided in the vehicle 100 via an in-vehicle network.

In the present embodiment, the vehicle 100 has a function of in-vehicle failure diagnostics (On-board diagnostics: OBD). The diagnostic data collection unit 140 performs diagnosis of an operation state of the vehicle 100. The diagnostic data collection unit 140 is connected to a motor control ECU, transmission ECU, brake ECU, motorized parking brake ECU, vehicle control device 110, etc. by an in-vehicle network.

Specifically, the diagnostic data collection unit 140 automatically checks the operation states of various devices such as actuators and various sensors included in the vehicle 100 at a predetermined cycle. In addition, when the occurrence of a failure is detected, the diagnostic data collection unit 140 stores the failure information in the memory included in the diagnostic data collection unit 140. The failure data is stored, for example, as a DTC code (Diagnostic Trouble Code).

The function of the diagnostic data collection unit 140 is realized by, for example, a diagnosis ECU included in the vehicles 100. In this instance, the diagnostic data collection unit 140 receives data indicating the status of the various devices and the detected values of the sensors from the respective ECU that control the various devices included in the vehicles 100. ECU for controlling the device include, for example, a motor control ECU for controlling an actuator of a drive device, a transmission ECU for controlling a transmission, a brake ECU for controlling an actuator of a braking device, and an electric parking brake ECU for controlling an electric parking brake. Incidentally, in FIG. 2, the motor control ECU, the transmission ECU, the brake ECU, is not shown such as an electric parking brake ECU.

Alternatively, the function of the diagnostic data collection unit 140 may be realized by a motor control ECU that controls an actuator of the drive device, a transmission ECU that controls a transmission, a brake ECU that controls an actuator of the braking device, and an electric parking brake ECU that controls an electric parking brake. ECU then stores the fault data.

In the present embodiment, when receiving the request message from the server 200, the diagnostic data collection unit 140 transmits a response message for responding to the request message to the server 200. The request message is, for example, a message instructing diagnosis of a specific device included in the vehicle 100. The response message is, for example, a message notifying the result of diagnosis of the apparatus.

The vehicle control unit 115 causes the vehicle 100 to travel by controlling the actuator group 120 using the travel control signal received from the server 200. The travel control signal is a control signal for causing the vehicle 100 to travel. In the present embodiment, the travel control signal includes the acceleration and the steering angle of the vehicle 100 as parameters. In other embodiments, the travel control signal may include the speed of the vehicle 100 as a parameter in place of or in addition to the acceleration of the vehicle 100.

The external sensor 300 is a sensor located outside the vehicle 100. The external sensor 300 in the present embodiment is a sensor that captures the vehicle 100 from the outside of the vehicle 100. The external sensor 300 includes a communication device (not shown), and can communicate with another device such as the server 200 by wired communication or wireless communication. Specifically, the external sensor 300 is constituted by a camera. The camera as the external sensor 300 captures an image of the vehicle 100 and outputs a captured image as a detection result.

The server 200 controls a moving object traveling by unmanned driving. The server 200 includes a computer including a processor 201, a memory 202, an input/output interface 203, and an internal bus 204. The server 200 is also referred to as a “control device”. The processor 201, the memory 202, and the input/output interface 203 are bidirectionally communicably connected via an internal bus 204. A communication device 205 for communicating with various devices external to the server 200 is connected to the input/output interface 203. The communication device 205 can communicate with the vehicle 100 by wireless communication, and can communicate with each external sensor 300 by wired communication or wireless communication.

The memory 202 stores program PG2, reference route RR, detection model DM, inspection items 31, execution points 32, and inspection loads 33. The memory 202 is also referred to as a “storage unit”.

The processor 201 executes the program PG2 to realize various functions including functions as the remote control unit 210, the position acquisition unit 220, the determination unit 230, the notification unit 240, the log output unit 250, and the inspection unit 260.

The reference route RR indicates a scheduled travel route of the vehicles 100. The travel route is represented by a node indicating a starting point, a node indicating a passing point, a node indicating a destination, and a link connecting the respective nodes.

The detection model DM is data representing a machine learning model that detects the external shape of the vehicle 100 included in the captured images acquired by the cameras that are the external sensors 300 when acquiring the vehicle position information.

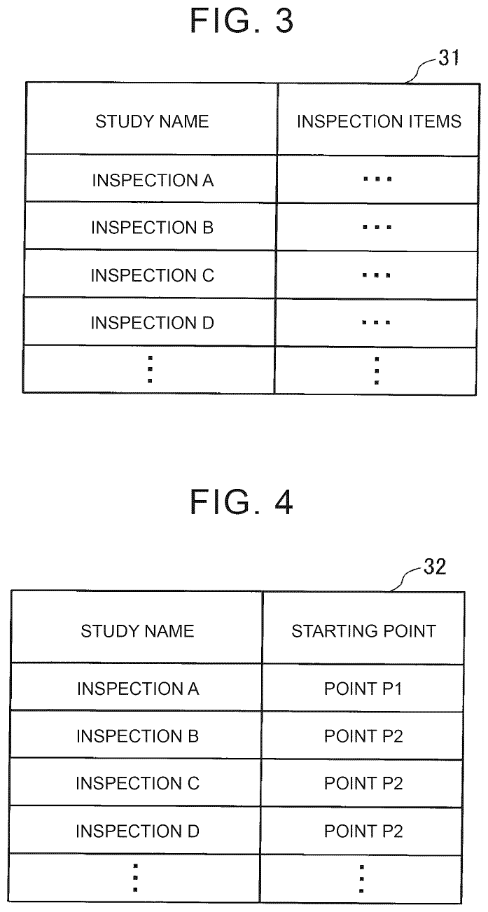

FIG. 3 is an explanatory diagram illustrating an example of the inspection item 31. The inspection item 31 is data defining a plurality of inspection items included in each inspection that can be performed on the vehicle 100. In the example illustrated in FIG. 3, the inspection item 31 is represented as a table in which a plurality of inspection items included in each inspection are set. In FIG. 3, the “inspection name” is a name for specifying a group of a plurality of inspection items.

FIG. 4 is an explanatory diagram illustrating an example of the execution point 32. The execution point 32 is data representing a point at which each inspection is started. In the example illustrated in FIG. 4, the execution point 32 is represented as a table in which information indicating a point at which an inspection is started is defined. The execution point 32 is also referred to as “first information”.

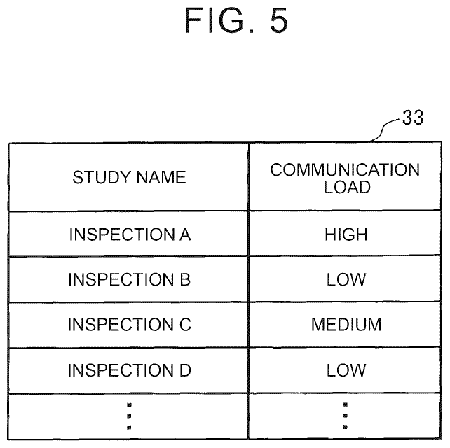

FIG. 5 is an explanatory diagram illustrating an example of the inspection load 33. The inspection load 33 is data representing a communication load in communication for each inspection. In the inspection, for example, in order to monitor the state of the vehicle 100, data indicating the state of each device controlled by each ECU and the detected value of the sensor is transmitted from the vehicle 100 to the server 200. Also, for active testing, a request message including a command may be transmitted from the server 200 to the vehicle 100. The active test is a test in which an ECU connected to a specific actuator is given an instruction such as actuation/deactivation of the actuator to individually confirm the operation of the specific actuator. In this way, at the time of inspection, data related to inspection is transmitted and received between the vehicle 100 and the server 200. The inspection load 33 represents, for each inspection, a communication load due to transmission and reception of data related to the inspection. In the example illustrated in FIG. 5, the inspection load 33 is represented as a table that defines, for each inspection, whether the communication load corresponds to “high”, “medium”, or “low”. The communication load “high” indicates that the communication load due to transmission and reception of data related to the inspection is high. The communication load “medium” indicates that the communication load due to the transmission and reception of the data related to the inspection is medium. The communication load “low” indicates that the communication load due to transmission and reception of data related to the inspection is low. For example, when the predicted value of the communication load predicted from the size of the data including the detected values of the command, the sensor, and the like transmitted and received between the vehicle 100 and the server 200 at the time of inspection is less than the first reference value determined in advance, the communication load is set to “low”. When the predicted value of the communication load is equal to or greater than the predetermined second reference value, the communication load is set to “high”. When the predicted value of the communication load is greater than or equal to the first reference value and less than the second reference value, the communication load is set to “medium”. The inspection load 33 is also referred to as “second information”.

The remote control unit 210 acquires a detection result by the sensor, and generates a travel control signal for controlling the actuator group 120 of the vehicle 100 using the detection result. The remote control unit 210 transmits a travel control signal to the vehicle 100 to cause the vehicle 100 to travel by remote control. The remote control unit 210 may generate and output not only a travel control signal but also a control signal for controlling various accessories provided in the vehicle 100 and actuators for operating various kinds of equipment such as a wiper, a power window, and a lamp. That is, the remote control unit 210 may operate the various types of equipment and the various accessories by remote control.

The position acquisition unit 220 acquires position information indicating the current position of the vehicle 100 using a captured image captured by a camera that is the external sensor 300. The determination unit 230 determines whether or not to cause the vehicle 100 to travel by unmanned driving based on the position information, the execution point 32, and the inspection load 33. The notification unit 240 notifies the administrator of the system 50, which is the user, of the result determined by the determination unit 230. The log output unit 250 outputs the result determined by the determination unit 230 as a log. The log output unit 250 is also called an “output unit”. The inspection unit 260 performs an inspection on the vehicle 100. Details of processing performed by the remote control unit 210, the position acquisition unit 220, the determination unit 230, the notification unit 240, the log output unit 250, and the inspection unit 260 will be described later.

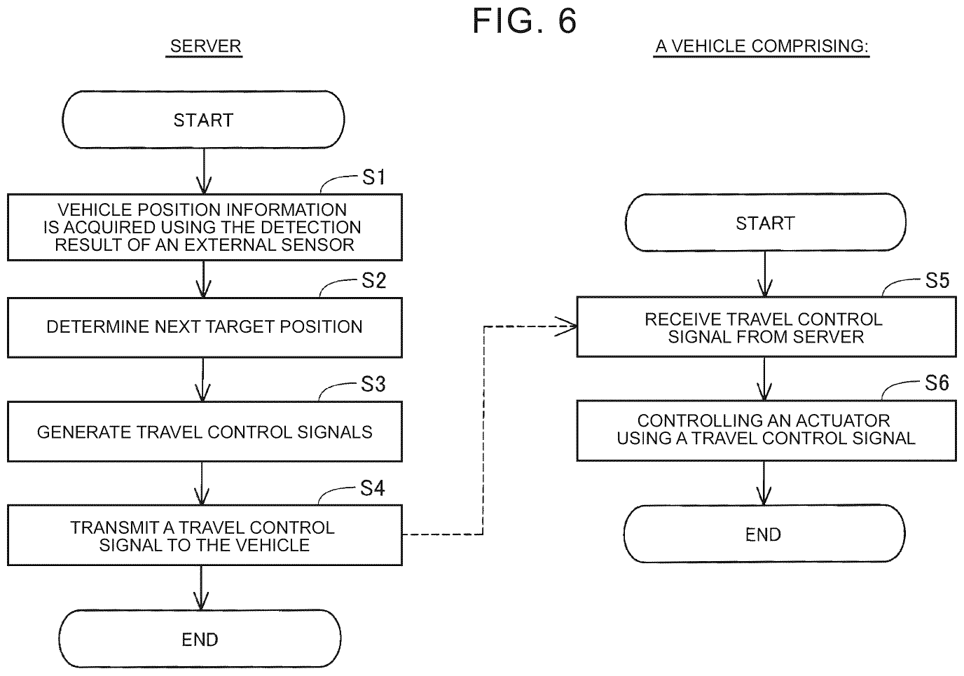

FIG. 6 is a flowchart illustrating a processing procedure of travel control of the vehicle 100 according to the first embodiment. The process of FIG. 6 is executed by the processor 201 of the server 200 functioning as the remote control unit 210 and the processor 111 of the vehicle 100 functioning as the vehicle control unit 115. For example, the process illustrated in FIG. 6 is repeatedly executed at predetermined time intervals from the time when the vehicle 100 starts traveling by remote control. For remote control, a travel control signal for causing the vehicle 100 to travel is transmitted and received between the communication device 130 of the vehicle 100 and the communication device 205 of the server 200. As described above, the communication device 130 is connected to DLC provided in the vehicles 100. For this reason, the transmission and reception of the travel control signal for causing the vehicle 100 to travel is performed via the same line as the line used for the diagnosis communication.

In step 1, the processor 201 of the server 200 acquires the vehicle position information using the detection result output from the external sensor 300. The vehicle position information is position information that is a basis for generating a travel control signal. In the present embodiment, the vehicle position information includes the position and orientation of the vehicle 100 in the global coordinate system GC of the factory FC. Specifically, in step 1, the processor 201 acquires the vehicle position information using the captured image acquired from the camera which is the external sensor 300.

Specifically, in step 1, the processor 201 detects, for example, an outer shape of the vehicle 100 from the captured image. Next, the processor 201 calculates the coordinates of the positioning point of the vehicle 100 in the coordinate system of the captured image, that is, the local coordinate system. Then, the processor 201 obtains the position of the vehicle 100 by converting the calculated coordinates into coordinates in the global coordinate system GC. The outline of the vehicle 100 included in the captured image can be detected by, for example, inputting the captured image into a detection model DM using artificial intelligence. The detection model DM is prepared in the system 50 or outside the system 50, for example, and stored in the memory 202 of the server 200 in advance. Examples of the detection model DM include a learned machine learning model that is learned so as to realize one of semantic segmentation and instance segmentation. As the machine learning model, for example, a convolutional neural network (hereinafter referred to as a CNN) learned by supervised learning using a learning dataset can be used. The training data set includes, for example, a plurality of training images including the vehicle 100 and a label indicating which of the regions in the training image indicates the vehicle 100 and the regions other than the vehicle 100. When CNN is learned, the parameters of CNN are preferably updated by back propagation so as to reduce the error between the output-result and-label due to the detection model DM. Further, the processor 201 estimates, for example, based on the orientation of the movement vector of the vehicle 100 calculated from the positional change of the feature point of the vehicle 100 between the frames of the captured image by using the optical flow method. Thus, the processor 201 can acquire the orientation of the vehicle 100.

In step 2, the processor 201 of the server 200 determines the target position to which the vehicle 100 should be heading next. In the present embodiment, the target position is represented by the coordinates of X, Y, Z in the global coordinate system GC. The processor 201 uses the vehicle position information and the reference route RR to determine the target position to which the vehicle 100 is to be directed next. The processor 201 determines the target position on the reference route RR ahead of the current position of the vehicles 100.

In step 3, the processor 201 of the server 200 generates a travel control signal for causing the vehicle 100 to travel toward the determined target position. The processor 201 calculates the traveling speed of the vehicle 100 from the transition of the position of the vehicle 100, and compares the calculated traveling speed with the target speed. The processor 201 generally determines the acceleration so that the vehicle 100 accelerates when the travel speed is lower than the target speed, and determines the acceleration so that the vehicle 100 decelerates when the travel speed is higher than the target speed. In addition, the processor 201 determines the steering angle and the acceleration so that the vehicle 100 does not deviate from the reference route RR when the vehicle 100 is located on the reference route RR. When the vehicle 100 is not located on the reference route RR, in other words, when the vehicle 100 deviates from the reference route RR, the processor 201 determines the steering angle and the acceleration so that the vehicle 100 returns to the reference route RR.

In step 4, the processor 201 of the server 200 transmits the generated travel control signal to the vehicle 100. The processor 201 repeats acquisition of position information of the vehicle 100, determination of a target position, generation of a travel control signal, transmission of a travel control signal, and the like at predetermined intervals.

In step 5, the processor 111 of the vehicle 100 receives the travel control signal transmitted from the server 200. In step 6, the processor 111 of the vehicle 100 controls the actuator group 120 using the received travel control signal, thereby causing the vehicle 100 to travel at the acceleration and the steering angle represented by the travel control signal. The processor 111 repeatedly receives the travel control signal and controls the actuator group 120 at a predetermined cycle. According to the system 50 of the present embodiment, the vehicle 100 can be driven by remote control, and the vehicle 100 can be moved without using a conveyance facility such as a crane or a conveyor.

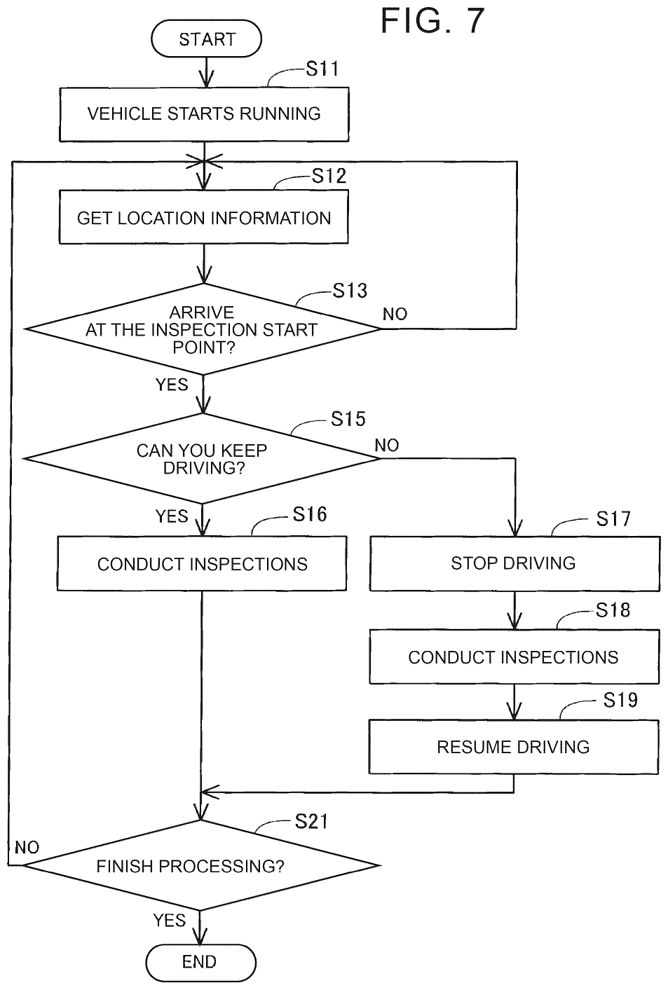

FIG. 7 is a flowchart illustrating a processing procedure related to inspection by the server 200. When the start condition is satisfied, the process illustrated in FIG. 7 is started. The start condition is that the vehicle 100 in the form of a completed vehicle is ready to travel when a specific predetermined process for the vehicle 100 is completed. The processor 201 acquires, for example, information on a process performed on the vehicle 100 from a higher server. It is assumed that, after each process is performed, for example, the operator notifies the higher server of the end of the process using the terminal device. Therefore, the host server has information on the process completed for the vehicle 100.

In step 11, the traveling of the vehicle 100 is started by remote control. The process of step 11 is executed by the processor 201 functioning as the remote control unit 210. Therefore, the traveling of the vehicle 100 is controlled in accordance with the processing procedure illustrated in FIG. 6.

In step 12, position information indicating the current position of the vehicle 100 is acquired using the captured image acquired from the camera which is the external sensor 300. The process of step 12 is executed by the processor 201 functioning as the position acquisition unit 220.

In step 13, it is determined whether or not the inspection start point has been reached. The processing of step 13 is executed by the processor 201 functioning as the determination unit 230. Specifically, when the position information acquired in step 12 matches any of the start points defined in the execution point 32 (see FIG. 4), it is determined that the inspection start point has been reached. Further, based on the execution point 32, the inspection to be performed next is identified. When it is determined that the inspection starting point has been reached (step 13; YES), the process of step 15 is executed. If it is determined that the inspection starting point has not been reached (step 13; NO), the process of step 12 is executed again.

In step 15, it is determined whether or not the vehicle 100 can continue traveling. Specifically, in a case where the communication load is set to “low” or “medium” in the inspection load 33 (see FIG. 5) for all of the one or more inspections performed next at the arrived start point, it is determined that the traveling can be continued. In addition, in a case where the communication load is set to “high” in the inspection load 33 for at least one of the one or more inspections performed at the arrived start point, it is determined that the traveling cannot be continued.

For example, as shown in the execution point 32 (see FIG. 4), the communication load is set to “high” at the inspection load 33 (see FIG. 5) for the inspection A performed at the point P1. In this case, it is determined that the traveling of the vehicle 100 cannot be continued when the inspection A is performed at the point P1.

Further, as shown in the execution point 32 (see FIG. 4), with respect to the inspections B to D performed at the point P2, the respective communication loads are set to “low” or “medium” at the inspection load 33 (see FIG. 5). In this case, it is determined that the traveling of the vehicles 100 can be continued when the inspections B to D are performed at the point P2.

As illustrated in FIG. 7, when it is determined in step 15 that the vehicle 100 can continue traveling, the administrator of the system 50, which is the user, is notified that the vehicle 100 continues traveling via the terminal device. Further, a log indicating that the vehicle 100 continues to travel is output to, for example, a predetermined area of the memory 202. When it is determined that the traveling of the vehicles 100 can be continued (step 15; YES), the process of step 16 is executed.

If it is determined in step 15 that the vehicle 100 cannot continue traveling, the administrator of the system 50, which is the user, is notified via the terminal device that the vehicle 100 cannot continue traveling. Further, a log indicating that the traveling of the vehicle 100 is interrupted is output to, for example, a predetermined area of the memory 202. When it is determined that the traveling of the vehicles 100 cannot be continued (step 15; NO), the process of step 17 is executed. The processing of step 15 is executed by the processor 201 functioning as the determination unit 230, the notification unit 240, and the log output unit 250.

In step 16, an inspection is performed. The processing of step 16 is executed by the processor 201 functioning as the inspection unit 260. Specifically, the inspection is performed for each of one or a plurality of inspection items set in the inspection item 31 (see FIG. 3) for the inspection to be performed next at the arrived start point. The server 200 and the vehicle 100 perform diagnostic communication for inspection.

If the inspection item is an active test for a particular actuator, the processor 201 sends a request message to the vehicle 100 that includes a command to activate the particular actuator. Further, the processor 201 receives a response message that includes a status value of a particular actuator that represents the result of the actuation indication. The processor 201 diagnoses the state of a particular actuator depending on whether the received state value satisfies a preset criterion.

Also, if the inspection item indicates that a particular sensor is to be monitored, the processor 201 sends a request message to the vehicle 100 requesting a detection value of the particular sensor. Further, the processor 201 receives a response message including a detection value of a specific sensor. After the processing of step 16 is executed, the processing of step 21 is executed.

In step 17, the vehicle 100 is stopped traveling. The process of step 17 is executed by the processor 201 functioning as the remote control unit 210. Here, it is assumed that the vehicle 100 and other subsequent vehicles are located at a sufficiently distant position. For example, when the vehicle 100 reaches the second location PL2, the driving of another vehicle following the first location PL1 is started.

An inspection is performed in step 18. The processing of step 18 is the same as that of step 16. The processing of step 18 is executed by the processor 201 functioning as the inspection unit 260.

In step 19, the vehicle 100 resumes running. The process of step 19 is executed by the processor 201 functioning as the remote control unit 210. Thereafter, the process of step 21 is executed.

In step 21, it is determined whether or not the process related to the inspection illustrated in FIG. 7 is to be terminated. For example, when the vehicle 100 arrives at the second location PL2, it is determined that the process related to the examination is ended. When it is determined that the process related to the inspection is ended (step 21; YES), the process illustrated in FIG. 7 is ended. If it is determined that the process related to the inspection is not ended (step 21; NO), the process of step 12 is executed again. The above is the processing procedure related to the inspection by the server 200.

In the present embodiment, the communication for the travel control of the vehicle 100 and the communication for the inspection of the vehicle 100 are performed via the same line. In such a mode, it is assumed that the communication band is compressed by both the communication for the travel control and the communication for the inspection, and a communication failure occurs. Furthermore, it may be difficult to ensure stable traveling of the vehicle 100 due to occurrence of a communication failure.

However, when it is determined that the load of the communication for inspection is high based on the position information indicating the current position of the vehicle 100 and the inspection load 33, the traveling of the vehicle 100 is stopped. In this way, it is possible to easily determine whether or not the vehicle 100 can travel.

In addition, when the communication load in the inspection performed by the inspection load 33 is set to “high”, it is determined that the vehicle 100 is stopped traveling. As described above, when the inspection is performed, the communication for controlling the travel of the vehicle 100 is restricted as necessary, so that it is possible to avoid the compression of the communication band.

### B. Second Embodiment

Hereinafter, the same configuration as that of the first embodiment will be omitted, and a configuration different from that of the first embodiment will be mainly described.

In the first embodiment, the inspection load 33 (see FIG. 5) defines which of “high”, “medium”, and “low” the communication load corresponds to for each inspection. Alternatively, a value representing the magnitude of the communication load for each inspection may be defined in the inspection load 33. The size of the communication load is a value estimated for each inspection from the size of data including detection values of commands, sensors, and the like transmitted and received between the vehicle 100 and the server 200 at the time of inspection.

In this case, in step 15 illustrated in FIG. 7, the processor 201 determines that the vehicle 100 cannot continue traveling when the value indicating the magnitude of the communication load defined in the inspection load 33 for the corresponding inspection is equal to or larger than a preset threshold value. In addition, when the value indicating the magnitude of the communication load of the corresponding inspection is less than a preset threshold value, it is determined that the vehicle 100 can continue traveling.

Also in the present embodiment, when it is determined that the load of the communication for inspection is high based on the position information indicating the current position of the vehicle 100 and the inspection load 33, the traveling of the vehicle 100 is stopped. As described above, it is possible to easily determine whether or not the vehicle 100 should continue traveling.

In addition, when the magnitude of the communication load in the inspection performed by the inspection load 33 is equal to or larger than the threshold value, it is determined that the traveling of the vehicle 100 is stopped. As described above, when the inspection is performed, the communication for controlling the travel of the vehicle 100 is restricted as necessary, so that it is possible to avoid the compression of the communication band.

### C. Third Embodiment

Hereinafter, the same configuration as that of the first embodiment will be omitted, and a configuration different from that of the first embodiment will be mainly described. In the third embodiment, a case where there is an inspection to be performed while the vehicle 100 is traveling will be described.

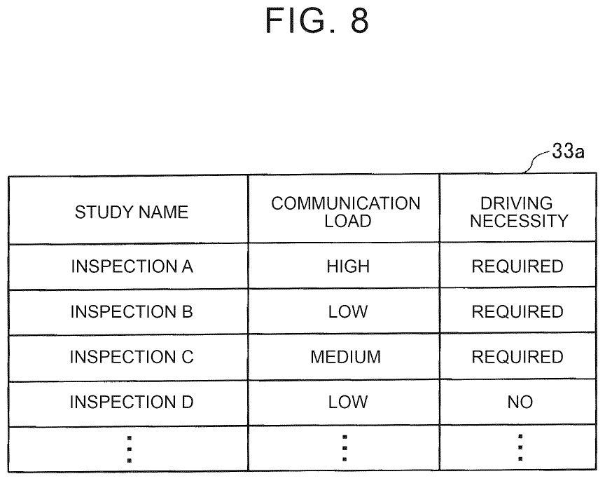

FIG. 8 is an explanatory diagram illustrating an exemplary inspection load 33a according to the third embodiment. In the exemplary embodiment illustrated in FIG. 8, the inspection load 33a defines the necessity of traveling of the vehicles 100 for each inspection in addition to the communication load for each inspection. The necessity of traveling of the vehicle 100 indicates whether or not the inspection requires traveling of the vehicle 100 when the inspection is performed.

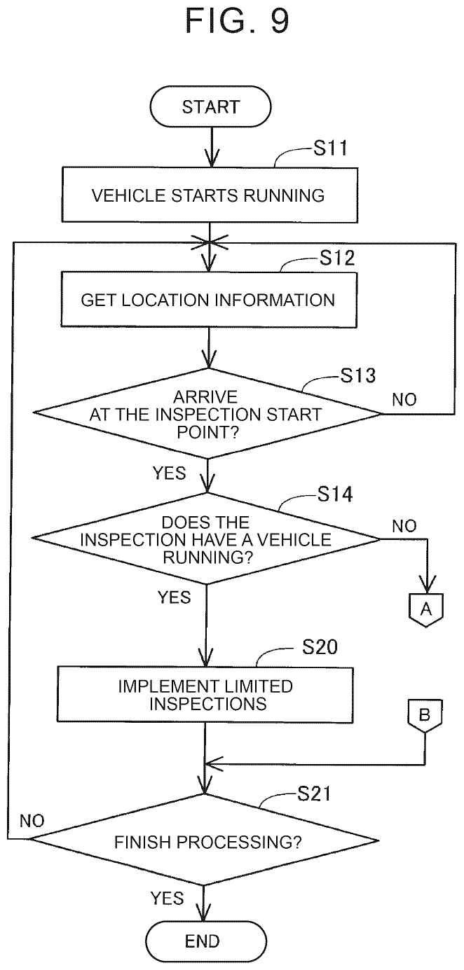

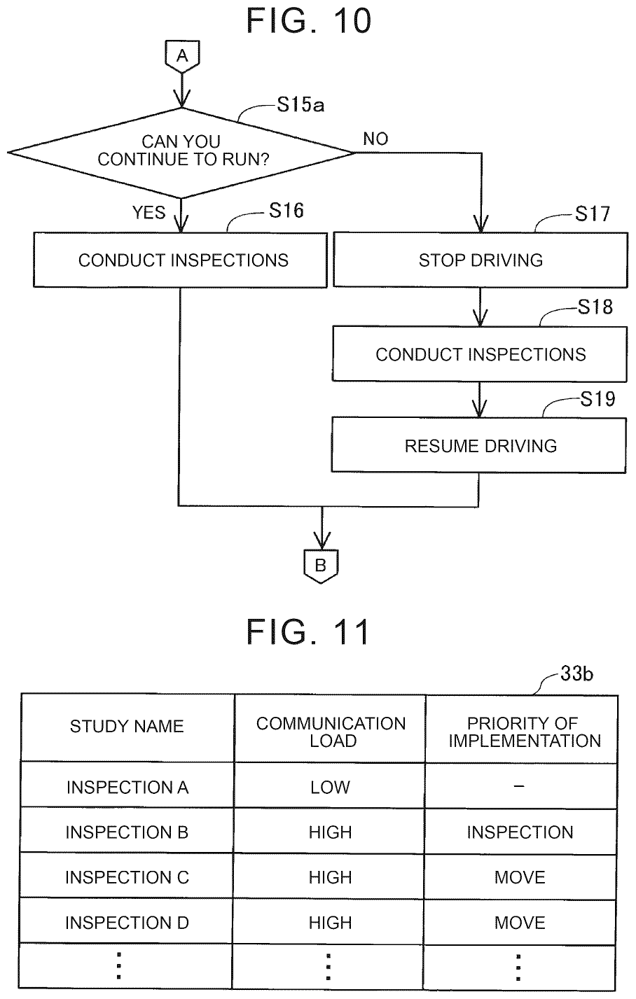

FIG. 9 and FIG. 10 are flowcharts illustrating a processing procedure related to an inspection in the present embodiment. When the start condition is satisfied, the process illustrated in FIG. 9 is started. The start condition is that the vehicle 100 in the form of a completed vehicle is ready to travel when a specific predetermined process for the vehicle 100 is completed. The processing from step 11 to step 13 shown in FIG. 9 is the same as that of the first embodiment.

In step 14, it is determined whether at least one of the one or more inspections performed next at the arrived start point requires the vehicle 100 to travel. Specifically, for each of the one or more inspections performed next at the arrived starting point, it is determined whether or not the necessity of traveling is set to “necessary” or “not” in the inspection load 33a (see FIG. 8). The processing of step 14 is executed by the processor 201 functioning as the determination unit 230.

When at least one of the one or more inspections performed next at the arrived starting point requires the traveling of the vehicles 100 (step 14; YES), a process of step 20 to be described later is executed. If all of the one or more inspections performed next at the arrived starting point do not require the vehicle 100 to travel (step 14; NO), the step 15a shown in FIG. 10 is performed.

In the step 15a, it is determined whether or not the traveling of the vehicles 100 can be continued. Specifically, in the inspection load 33a, when the communication load is set to “low” or “medium” for all of the one or more inspections performed next at the arrived starting point, it is determined that the traveling of the vehicles 100 can be continued. Further, in the inspection load 33a, when the communication load is set to “high” for at least one of the one or more inspections performed next at the arrived starting point, it is determined that the traveling of the vehicle 100 cannot be continued.

For example, with respect to the inspections B to D performed at the point P2 as shown at the execution point 32 (see FIG. 4), the respective communication loads are set to “low” or “medium” at the inspection load 33 (see FIG. 5). In this case, it is determined that the traveling can be continued in order to perform the inspections B to D at the point P2.

As illustrated in FIG. 10, when it is determined in the step 15a that the vehicle 100 can continue traveling, the administrator of the system 50, which is the user, is notified that the vehicle 100 continues traveling via the terminal device. Further, a log indicating that the vehicle 100 continues to travel is output to, for example, a predetermined area of the memory 202. When it is determined that the traveling of the vehicles 100 can be continued (step 15a; YES), the process of step 16 is executed. The process of step 16 is the same as that of the first embodiment. After the processing of step 16 is executed, the processing of step 21 shown in FIG. 9 is executed.

When it is determined in the step 15a that the vehicle 100 cannot continue traveling, the administrator of the system 50, which is the user, is notified via the terminal device that the vehicle 100 cannot continue traveling. Further, a log indicating that the traveling of the vehicle 100 is interrupted is output to, for example, a predetermined area of the memory 202. When it is determined that the traveling of the vehicles 100 cannot be continued (step 15a; NO), the process of step 17 is executed. The process of the step 15a is executed by the processor 201 functioning as the determination unit 230, the notification unit 240, and the log-output unit 250. The processing of steps 17 to 19 is the same as that of the first embodiment. After the processing of step 19 is executed, the processing of step 21 shown in FIG. 9 is executed.

In step 20 shown in FIG. 9, a limited inspection is performed. As described above, if at least one of the one or more inspections performed next at the arrived start point requires the vehicle 100 to travel, the process of step 20 is performed. In step 20, in particular, an inspection is performed on some inspection items of one or more inspections which are performed next at the arrived start point and which require the travel of the vehicle 100.

For example, as illustrated in the execution point 32 (see FIG. 4), the inspection A is performed at the point P1 as the starting point. In the inspection load 33a (see FIG. 8), the inspection A is an inspection that requires the vehicle 100 to travel. In this case, it is determined to perform an inspection on some of the plurality of inspection items set for the inspection A. Then, an inspection is performed on the determined part of the inspection items.

For example, half of the plurality of inspection items may be selected. Alternatively, among the plurality of inspection items, only an inspection item in which the size of data including detection values of a command, a sensor, or the like to be transmitted and received is equal to or smaller than a predetermined reference value may be selected at the time of inspection of the inspection item. Alternatively, one or more inspection items among the plurality of inspection items may be selected based on a predetermined priority. The processing of step 20 is executed by the processor 201 functioning as the determination unit 230 and the inspection unit 260. The process of step 21 is the same as that of the first embodiment.

In the present embodiment, when the inspection requiring the traveling of the vehicle 100 is performed, only some inspection items of the inspection are performed without interrupting the traveling of the vehicle 100. Therefore, it is possible to prevent the communication band from being compressed by the remote control for traveling of the vehicle and the execution of the inspection.

### D. Fourth Embodiment

Hereinafter, the same configuration as that of the first embodiment will be omitted, and a configuration different from that of the first embodiment will be mainly described.

FIG. 11 is an explanatory diagram illustrating an exemplary inspection load 33b according to the fourth embodiment. In the exemplary embodiment illustrated in FIG. 11, the degree of the communication load for each inspection is defined in the inspection load 33b. Further, in the inspection load 33b, for an inspection in which the communication load is set to be “high”, information indicating which one of the inspection execution and the moving of the vehicle 100 should be preferentially performed is defined. In the case of indicating that the execution of the inspection should be prioritized among the execution of the inspection and the movement of the vehicle 100, “inspection” is set to “priority of execution”. In the case of indicating that the movement of the vehicle 100 should be prioritized among the execution of the inspection and the movement of the vehicle 100, “movement” is set to “priority of execution”.

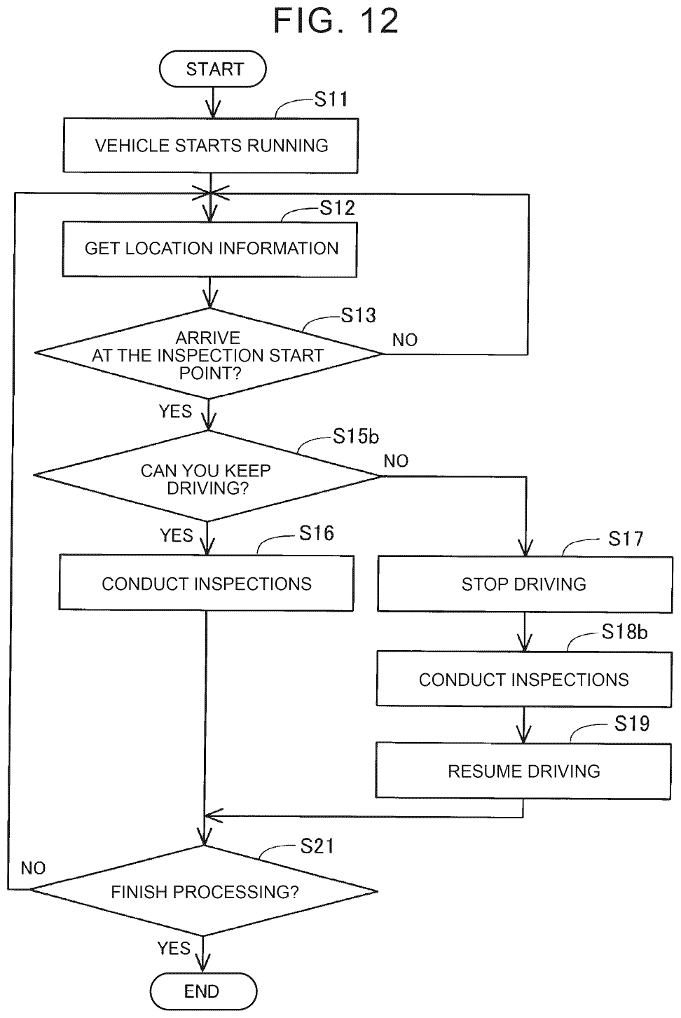

FIG. 12 is a flowchart illustrating a processing procedure related to inspection by the server 200. When the start condition is satisfied, the process illustrated in FIG. 12 is started. The start condition is that the vehicle 100 in the form of a completed vehicle is ready to travel when a specific predetermined process for the vehicle 100 is completed. Steps 11 to 13 are the same as those of the first embodiment.

In the step 15b, it is determined whether or not the traveling of the vehicles 100 can be continued.

Specifically, when the communication load is set to “low” or “medium” for all of the one or more inspections performed next at the starting point reached in the inspection load 33b (see FIG. 11), it is determined that the traveling can be continued.

In addition, for at least one of the one or more inspections performed at the arrived starting point, the communication load may be set to “high” in the inspection load 33b. In this case, it is further determined whether the priority of the execution of the corresponding inspection is “inspection” or “movement”. In the inspection load 33b, for an inspection in which the communication load is set to “high” and the priority of the execution is set to “move”, it is determined to omit the execution of the inspection at the arrived starting point. For inspections where the communication load is set to “High” and the priority of execution is set to “Inspection”, it is decided to execute the inspection at the arrived start point.

In addition, in a case where there is at least one inspection in which the communication load is set to “high” and the priority of the execution is set to “inspection” among the one or more inspections performed at the arrived start point, it is determined that the vehicle 100 cannot continue traveling. In addition, when the priority of all the execution of the one or more inspections performed at the arrived start point is set to “move”, it is determined that the traveling can be continued.

For example, with respect to the inspections B to D performed at the point P2 as shown in the execution point 32 (see FIG. 4), the respective communication loads are set to “high” in the inspection load 33b (see FIG. 11). Among the inspections B to D, only the inspection B is the “inspection” as the priority of the execution. Therefore, it is determined that the inspection B is performed at the point P2 and the execution of the inspections C to D is omitted. In addition, since the inspection B is performed, it is determined that the traveling cannot be continued.

As illustrated in FIG. 12, when it is determined in the step 15b that the vehicle 100 can continue traveling, the administrator of the system 50, which is the user, is notified that the vehicle 100 continues traveling via the terminal device. In addition, in a case where there is an inspection in which the execution is omitted at the point, information on the inspection to be omitted is notified to the administrator of the system 50 that is the user via the terminal device. Further, a log indicating that the vehicle 100 continues to travel is output to, for example, a predetermined area of the memory 202. In addition, in a case where there is an inspection in which the execution is omitted at the point, the information of the inspection to be omitted is output to the log. When it is determined that the traveling of the vehicles 100 can be continued (step 15b; YES), the process of step 16 is executed. Step 16 is the same as the first embodiment.

When it is determined in the step 15b that the vehicle 100 cannot continue traveling, the administrator of the system 50, which is the user, is notified via the terminal device that the vehicle 100 cannot continue traveling. In addition, in a case where there is an inspection in which the execution is omitted at the point, information on the inspection to be omitted is notified to the administrator of the system 50 that is the user via the terminal device. Further, a log indicating that the traveling of the vehicle 100 is interrupted is output to, for example, a predetermined area of the memory 202. In addition, in a case where there is an inspection in which the execution is omitted at the point, the information of the inspection to be omitted is output to the log. When it is determined that the traveling of the vehicles 100 cannot be continued (step 15b; NO), the process of step 17 is executed. The process of the step 15b is executed by the processor 201 functioning as the determination unit 230, the notification unit 240, and the log-output unit 250. Step 17 is the same as the first embodiment.

In a 18b of steps, an inspection is performed. In 18b of steps, only those inspections determined to be performed at the arriving starting point are performed. That is, in the inspection load 33b, only the inspection in which the communication load is set to “high” and the priorities of execution are set to “inspection” is performed. The processing of step 18 is executed by the processor 201 functioning as the inspection unit 260.

Steps 19 and 21 are the same as in the first embodiment. The above is the processing procedure related to the inspection by the server 200.

Further, the omitted examination is performed after the vehicles 100 arrive at the second location PL2, for example. When the vehicle 100 arrives at the second location PL2, the communication for the travel control of the vehicle 100 is stopped. As a result, only the communication for the inspection is performed on the same line among the communication for the travel control of the vehicle and the communication for the inspection. Therefore, the server 200 can perform the inspection omitted for the vehicle 100 without compressing the communication band.

In the present embodiment, it is possible to easily determine which of the moving object and the inspection execution should be prioritized based on the position information indicating the present position of the vehicle 100 and the inspection load 33b.

### E. Other Embodiments

(E1) In the first embodiment, an example in which the server 200 includes the notification unit 240 has been described, but the server 200 may not include the notification unit 240. Further, in the first embodiment, an example has been described in which the server 200 includes the log output unit 250, but the server 200 may not include the log output unit 250.

(E2) In the first embodiment described above, when it is determined that the driving cannot be continued after reaching the inspection starting point (see step 15 in FIG. 7), the driving of the vehicles 100 is stopped on the road TR (see step 17 in FIG. 7).

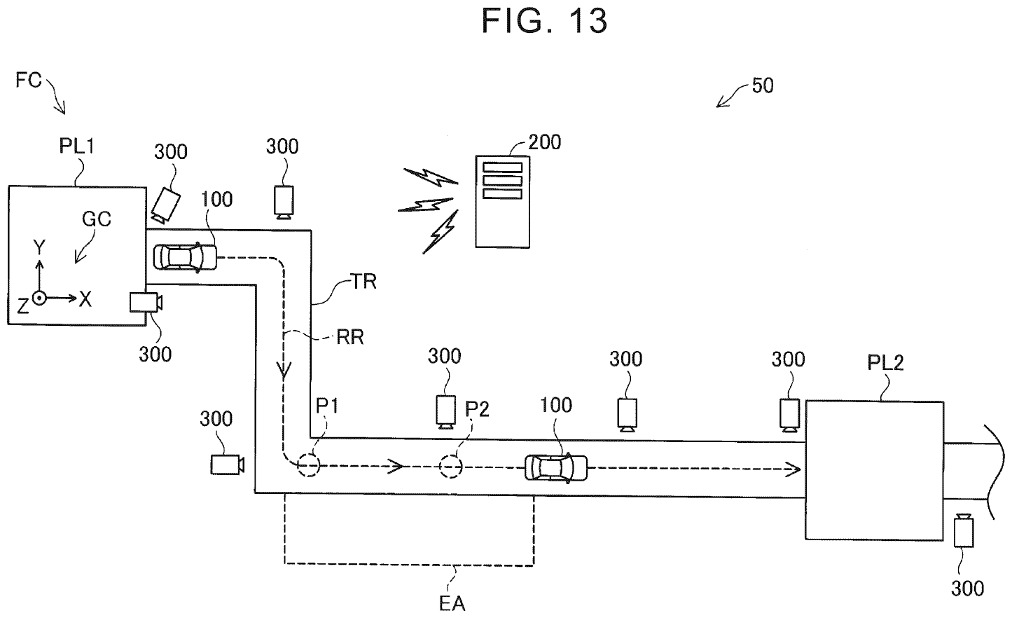

FIG. 13 is an explanatory diagram of a situation where the vehicles 100 are evacuated to the evacuation area EA. When the processor 201 of the server 200 determines that the vehicle 100 has reached the inspection starting point and cannot continue traveling, the vehicle 100 may be evacuated to the evacuation area EA. The processor 201 generates a travel control signal for causing the vehicles 100 to travel toward the evacuation area EA which is the target position. Further, the processor 201 performs an inspection on the vehicle 100 after moving the vehicle 100 to the evacuation area EA. By stopping the vehicle 100, it is possible to prevent the vehicle 100 and other subsequent vehicles from traveling. In the first embodiment, when the vehicle 100 reaches the second location PL2, the operation is performed in which the starting condition that the subsequent other vehicle can start traveling from the first location PL1 is satisfied. However, in the present embodiment, such an operation is unnecessary.

(E3) In the present disclosure, “moving object” means a movable object, and is, for example, a vehicle or an electric vertical takeoff and landing machine (a so-called flying vehicle). The vehicle may be a vehicle traveling by a wheel or a vehicle traveling by an infinite track, and is, for example, a passenger car, a truck, a bus, a two-wheeled vehicle, a four-wheeled vehicle, a tank, a construction vehicle, or the like. Vehicles include BEV, gasoline-powered vehicles, hybrid electric vehicle, and fuel cell electric vehicle. When the moving body is other than the vehicle, the expressions of “vehicle” and “vehicle” in the present disclosure can be appropriately replaced with “moving body”, and the expression of “traveling” can be appropriately replaced with “moving”.

(E4) In each of the above-described embodiments, the external sensor 300 is not limited to a camera, and may be, for example, a distance measuring device. The distance measuring device is, for example, a LiDAR (Light Detection and Ranging). In this case, the detection result output by the external sensor 300 may be three-dimensional point cloud data representing the vehicle 100. In this case, the server 200 or the vehicle 100 may acquire the vehicle position information by template matching using three-dimensional point cloud data as a detection result and reference point cloud data prepared in advance.

(E5) In the first embodiment, the server 200 executes processing from acquisition of vehicle position information to generation of a travel control signal. On the other hand, at least a part of the processing from the acquisition of the vehicle position information to the generation of the travel control signal may be executed by the vehicle 100. For example, the following forms (1) to (3) may be used.

(1) The server 200 may acquire the vehicle position information, determine a target position to which the vehicle 100 should be heading next, and generate a route from the current position of the vehicle 100 represented by the acquired vehicle position information to the target position. The server 200 may generate a route to a target position between the current location and the destination, or may generate a route to the destination. The server 200 may transmit the generated route to the vehicle 100. The vehicle 100 may generate a travel control signal so that the vehicle 100 travels on the route received from the server 200, and control the actuator group 120 using the generated travel control signal.

(2) The server 200 may acquire the vehicle position information and transmit the acquired vehicle position information to the vehicle 100. The vehicle 100 determines a target position to which the vehicle 100 should be headed next, and generates a route from the current position of the vehicle 100 represented by the received vehicle position information to the target position. The vehicle 100 may generate a travel control signal so that the vehicle 100 travels on the generated route, and control the actuator group 120 using the generated travel control signal.

(3) In the above forms (1) and (2), an internal sensor may be mounted on the vehicle 100, and a detection result output from the internal sensor may be used for at least one of generation of a route and generation of a travel control signal. The internal sensor is a sensor mounted on the vehicle 100. The internal sensor may include, for example, a sensor that detects a motion state of the vehicle 100, a sensor that detects an operation state of each unit of the vehicle 100, and a sensor that detects an environment around the vehicle 100. Specifically, the inner sensor may include, for example, a camera, a LiDAR, a millimeter-wave radar, an ultrasonic sensor, a GPS sensor, an accelerometer, a gyroscope, and the like. For example, in the form (1), the server 200 may acquire the detection result of the internal sensor and reflect the detection result of the internal sensor in the path when generating the path. In the form (1), the vehicle 100 may acquire the detection result of the internal sensor and reflect the detection result of the internal sensor in the travel control signal when generating the travel control signal. In the form (2), the vehicle 100 may acquire the detection result of the internal sensor and reflect the detection result of the internal sensor in the path when generating the path. In the form (2), the vehicle 100 may acquire the detection result of the internal sensor and reflect the detection result of the internal sensor in the travel control signal when generating the travel control signal.

(E6) The vehicle 100 may be manufactured by combining a plurality of modules. A module refers to a unit composed of one or more components grouped according to the configuration and function of the vehicle 100. For example, the platform of the vehicle 100 may be manufactured by combining a front module that constitutes a front portion of the platform, a central module that constitutes a central portion of the platform, and a rear module that constitutes a rear portion of the platform. The number of modules constituting the platform is not limited to three, and may be two or less or four or more. In addition to or instead of the platform, a different part of the vehicle 100 from the platform may be modularized. Further, the various modules may include any exterior parts such as bumpers and grills, and any interior parts such as sheets and consoles. In addition, not only the vehicle 100 but also a moving object of an arbitrary mode may be manufactured by combining a plurality of modules. Such a module may be manufactured, for example, by joining a plurality of parts by welding, a fixture, or the like, or may be manufactured by integrally molding at least a part of the module as one part by casting. Molding techniques for integrally molding at least a portion of a module as one part are also referred to as gigacasting or megacasting. By using the gigacasting, each part of the moving body, which has been conventionally formed by joining a plurality of parts, can be formed as one part. For example, the front module, the central module, and the rear module described above may be manufactured using gigacasting.

(E7) Transporting the vehicle 100 by using the traveling of the vehicle 100 by the unmanned driving is also referred to as “self-propelled conveyance”. A configuration for realizing self-propelled conveyance is also referred to as a “vehicle remote control autonomous traveling conveyance system”. Further, a production method of producing the vehicle 100 by using self-propelled conveyance is also referred to as “self-propelled production”. In self-propelled manufacturing, for example, at least a part of conveyance of the vehicle 100 is realized by self-propelled conveyance in a factory FC that manufactures the vehicle 100.

(E8) In the first to fourth embodiments described above, an example in which the inspection can be performed on the vehicle 100 in the state of the completed vehicle has been described. However, it is not limited thereto. The vehicle 100 may be provided with a configuration that can be moved by unmanned driving, and may be, for example, in the form of a platform having a configuration described below. The inspection may be performed on the vehicle 100 in the state of the platform. Specifically, the vehicle 100 may include at least a control device that controls the travel of the vehicle 100 and actuators such as a drive device, a steering device, and a braking device in order to perform three functions of “running”, “turning”, and “stopping” by unmanned driving. When the vehicle 100 acquires information from the outside for unmanned driving, the vehicle 100 may further include a communication device. That is, the vehicle 100 that can be moved by the unmanned driving may not be equipped with at least a part of an interior component such as a driver's seat or a dashboard. Further, the vehicle 100 may not be equipped with at least a part of exterior components such as a bumper and a fender, and may not be equipped with a body shell. In this case, the remaining components such as the body shell may be mounted on the vehicle 100 until the vehicle 100 is shipped from the factory. Further, in a state in which the remaining components such as the body shell are not mounted on the vehicle 100, the remaining components such as the body shell may be mounted on the vehicle 100 after the vehicle 100 is shipped from the factory. Each of the components may be mounted from any direction, such as the upper side, lower side, front side, rear side, right side or left side of the vehicle 100, each may be mounted from the same direction, or may be mounted from a different direction. It should be noted that the position determination can also be performed for the form of the platform in the same manner as the vehicle 100 according to the first embodiment.

(E9) In each of the above-described embodiments, some or all of the functions and processes implemented in software may be implemented in hardware. In addition, some or all of the functions and processes implemented in hardware may be implemented in software. For example, various circuits such as an integrated circuit and a discrete circuit may be used as hardware for realizing various functions in the above-described embodiments.

The present disclosure is not limited to each of the above embodiments, and can be realized by various configurations without departing from the spirit thereof. For example, the technical features in the embodiments corresponding to the technical features in the respective aspects described in the summary column of the disclosure can be appropriately replaced or combined in order to solve the above-described problem or to achieve some or all of the above-described effects. In addition, if the technical features are not described as being essential in the present specification, they can be deleted as appropriate.

What is claimed is:

1. A control device that controls a mobile body that travels through unattended driving, the control device and the mobile body performing communication for controlling travel of the mobile body through the unattended driving and communication for inspecting the mobile body via an identical line, the control device comprising:
a position acquisition unit that acquires position information that indicates a current position of the mobile body;
a storage unit that stores
first information that indicates one or more inspections performed on the mobile body on a scheduled travel route of the mobile body and a point associated with each of the inspections where the inspection is performed on the travel route, and
second information that indicates a communication load in communication for the inspection and associated with the inspection; and
a determination unit that determines whether to cause the mobile body to travel through the unattended driving based on the position information, the first information, and the second information.

2. The control device according to claim 1, wherein the determination unit is configured to:
specify the inspection to be performed next based on the position information and the first information; and
determine not to cause the mobile body to travel through the unattended driving when the communication load in execution of the specified inspection meets a condition determined in advance based on the specified inspection and the second information.

3. The control device according to claim 1, wherein:
the second information further includes information that indicates whether travel of the mobile body is required for the inspection; and
the determination unit is configured to
specify the inspection to be performed next based on the position information and the first information,
determine based on the second information whether travel of the mobile body is enabled for the specified inspection, and
when the specified inspection requires travel of the mobile body,
cause the mobile body to travel through the unattended driving, and
determine to perform only an inspection item that requires travel based on the second information, among a plurality of inspection items included in the specified inspection.

4. The control device according to claim 1, wherein:
the second information further includes information that indicates a process to be preferentially performed, among execution of the inspection and movement of the mobile body; and
the determination unit is configured to
specify the inspection to be performed next based on the position information and the first information,
when it is determined to perform the execution of the specified inspection in preference to the movement of the mobile body, perform the specified inspection without causing the mobile body to travel, and
when it is determined to perform the movement of the mobile body in preference to the execution of the specified inspection, cause the mobile body to travel, stop communication for controlling travel of the mobile body when the mobile body arrives at a destination, and thereafter perform the inspection.

5. The control device according to claim 1, further comprising at least one of:
a notification unit that notifies a user that the mobile body is caused to travel through the unattended driving when the determination unit determines to cause the mobile body to travel through the unattended driving; or
an output unit that outputs a log that indicates that the determination unit has determined to cause the mobile body to travel through the unattended driving when the determination unit makes such a decision.
